(19) United States
(12) Patent Application Publication
(10) Pub. No.: US 2025/0235832 A1
(43) Pub. Date: Jul. 24, 2025

(54) PADDLE DISCARDING FULLY-SEALED CEMENT STIRRING AND SOLIDIFICATION BUCKET AND LIQUID INJECTION AND STIRRING METHOD

(71) Applicant: China National Nuclear Corporation Sichuan Environmental Protection Engineering Co., Ltd., Guangyuan (CN)

(72) Inventors: Hongsheng YANG, Guangyuan (CN); Kexin ZHANG, Guangyuan (CN); Changsheng HE, Guangyuan (CN); Yue WANG, Guangyuan (CN); Yufeng ZENG, Guangyuan (CN); Yong ZHANG, Guangyuan (CN); Shenbao LIU, Guangyuan (CN); Huizhu SONG, Guangyuan (CN); Jinlong HOU, Guangyuan (CN); Li WAN, Guangyuan (CN); Jianqiang JIN, Guangyuan (CN); Binghao ZHAO, Guangyuan (CN); Cheng XIONG, Guangyuan (CN); Ling MAO, Guangyuan (CN)

(21) Appl. No.: 18/936,168

(22) Filed: Nov. 4, 2024

(30) Foreign Application Priority Data
Jan. 24, 2024 (CN) 2024101051343

(51) Int. Cl. B01F 23/53; B01F 23/50; B01F 27/88; B01F 27/90; B01F 35/45; B01F 101/28; B01F 101/57

(52) U.S. Cl. CPC B01F 23/53; B01F 23/51; B01F 27/88; B01F 27/90; B01F 35/45; B01F 2101/28; B01F 2101/57; B01F 2215/0409; B01F 2215/0454

(57) ABSTRACT

Disclosed are a paddle discarding fully-sealed cement stirring and solidification bucket and a liquid injection and stirring method. A stirring paddle, a bucket cover, and a stirring steel bucket are first assembled and conveyed to a feeding station for cover removal and cement filling; then the stirring steel bucket is conveyed to a stirring station; after a stirring power device, a waste liquid injection device, and a breathing and exhaust device are correspondingly connected to a stirring paddle drive connection end, a waste liquid injection interface, and a breathing and exhaust device interface, injection and stirring of radioactive waste liquid are carried out in a fully-sealed environment. In the present invention, the stirring paddle is discarded in the steel bucket, thereby avoiding the problems of secondary radioactive waste liquid produced by cleaning the stirring paddle and diffusion of radioactive aerosol in the stirring process.

### CROSS-REFERENCE TO RELATED APPLICATIONS

The present application claims priority to Chinese Patent Application No. 2024101051343, filed on Jan. 24, 2024, the entire disclosure of which is incorporated herein by reference.

### TECHNICAL FIELD

The present invention relates to the technical field of radioactive waste treatment, in particular to a paddle discarding fully-sealed cement stirring and solidification bucket and a liquid injection and stirring method.

### BACKGROUND

The paddle discarding fully-sealed stirring bucket cement solidification process is a type of radioactive waste liquid bucket cement solidification technology. Different from other non-sealed bucket cement solidification processes, this process adopts a paddle discarding and sealed mode, where stirring and curing of cement mortar in the bucket are always carried out in a fully-sealed state, which will not cause pollution to the production line and solidification bucket. In radioactive waste liquid cement solidification processes, stirring is a necessary condition for uniform distribution of cement and radioactive waste liquid. However, for the paddle discarding fully-sealed stirring bucket cement solidification process, the stirring process is not mature enough, and there are still problems such as non-uniform stirring, overflow of waste liquid from a solidification bucket, clamping stagnation of a stirring device, fracture of a stirring paddle shaft, and burnout of a motor during stirring. The main reasons are as follows: i. the sealing of the solidification bucket does not meet the requirements of the stirring process, and ii. the method and parameters of the stirring process are unreasonable.

### SUMMARY

The objective of the present invention is to provide a paddle discarding fully-sealed cement stirring and solidification bucket and a liquid injection and stirring method, which aim to solve the problems of leakage of radioactive waste liquid, clamping stagnation and fracture of a stirring device, and unsatisfactory performance of a cement solidified body caused by inadequate sealing of a solidification bucket and unreasonable parameter settings in the stirring process of the paddle discarding fully-sealed stirring bucket cement solidification process.

To achieve the above objective, the present invention is implemented according to the following technical solution:

A paddle discarding stirring bucket for radioactive waste liquid cement solidification in the present invention includes a steel bucket, a stirring paddle, bucket cover bolts, a stirring paddle drive connection end, a breathing and exhaust device interface, a waste liquid injection interface, and a bucket cover, where an upper end of the stirring paddle is the stirring paddle drive connection end, the stirring paddle drive connection end is integrally formed with the stirring paddle, the stirring paddle drive connection end passes through a lower end of the bucket cover, an upper segment of the stirring paddle is connected to the bucket cover in a sealed and rotatable manner, a lower segment of the stirring paddle is located inside the stirring steel bucket, the breathing and exhaust device interface and the waste liquid injection interface are both arranged on the bucket cover, and an edge of the bucket cover is detachably connected to an upper end of the stirring steel bucket by the bucket cover bolts.

A solidification and stirring method for the paddle discarding stirring bucket for radioactive waste liquid cement solidification in the present invention includes the following steps:
S1: assembling the stirring paddle, the bucket cover, and the stirring steel bucket and then conveying them to a feeding station for cover removal and cement filling;
S2: conveying the stirring steel bucket to a stirring station, connecting a stirring power device, a waste liquid injection device, and a breathing and exhaust device to the stirring paddle drive connection end, the waste liquid injection interface, and the breathing and exhaust device interface correspondingly, and then carrying out injection and stirring of radioactive waste liquid in a fully-sealed environment;
where the injection and stirring of radioactive waste liquid in the fully-sealed environment includes three steps: cement dry ash stirring, waste liquid injection into the steel bucket and stirring, and uniform mixing:
the cement dry ash stirring is set with a stirring time of 3-5 minutes and a stirring speed of 60-70 revolutions per minute.

The waste liquid injection into the steel bucket and stirring include an initial stirring stage and a suspension stirring stage;
the initial stirring stage is a solid-liquid mixing stage in which the speed of the stirring paddle is 80-90 revolutions per minute;
the injection amount and injection time of waste liquid are calculated using the following formulas, and the injection amount and injection time of waste liquid in the initial stirring stage are set according to the ranges of parameters in the formulas:

$$V = kW / ρ \qquad ( 1 )$$

$${T}_{0} = kW / Q \qquad ( 2 )$$

V is a cumulative injection amount of waste liquid in the initial stirring stage;
T₀ is an injection time;
ρ is a density of waste liquid;
Q is an injection flow rate of waste liquid, stably controlled at 3-4 cubic meters per hour;
W is a total weight of pre-loaded cement, calculated based on a water cement ratio of a cement solidification formula;
K is a control coefficient for the cumulative injection amount of waste liquid in the initial stirring stage, ranging from 17% to 22%;
the suspension stirring stage is a solid-liquid suspension mixing stage, the injection flow rate of the waste liquid is reduced to 70-80% of the initial stirring stage until all the waste liquid is injected, and the speed of the stirring paddle remains 80-90 revolutions per minute.

The uniform mixing includes a thorough mixing stage, a strong stirring stage, and a uniformity improving stirring stage;
the thorough mixing stage is set with a stirring time of 10 minutes and a stirring speed of 90-100 revolutions per minute;
the strong stirring stage is set with a stirring time of 5 minutes and a stirring speed of 120 revolutions per minute; and
the uniformity improving stirring stage is set with a stirring time of 2 minutes and a stirring speed of 90-100 revolutions per minute.
S3: transferring the stirring steel bucket 6 to a temporary store for maintenance after the stirring is completed.

Beneficial effects of the present invention are as follows:
The present invention discloses a paddle discarding fully-sealed cement stirring and solidification bucket and a liquid injection and stirring method. Compared with the prior art, the stirring paddle is discarded in the steel bucket, and the radioactive waste liquid and cement are solidified in the fully-sealed environment, thereby avoiding the problems of secondary radioactive waste liquid produced by cleaning the stirring paddle and diffusion of radioactive aerosol in the stirring process.

### BRIEF DESCRIPTION OF DRAWINGS

FIG. 1 is a schematic diagram of a partial cross-sectional structure of a stirring and solidification bucket of the present invention; and

FIG. 2 is a schematic diagram of a cross-sectional structure of a stirring bucket cover of the present invention.

### DETAILED DESCRIPTION OF THE EMBODIMENTS

The present invention will be further described in conjunction with the accompanying drawings and specific embodiments. The illustrative embodiments and explanations provided herein are intended to explain the present invention, but not to limit the present invention.

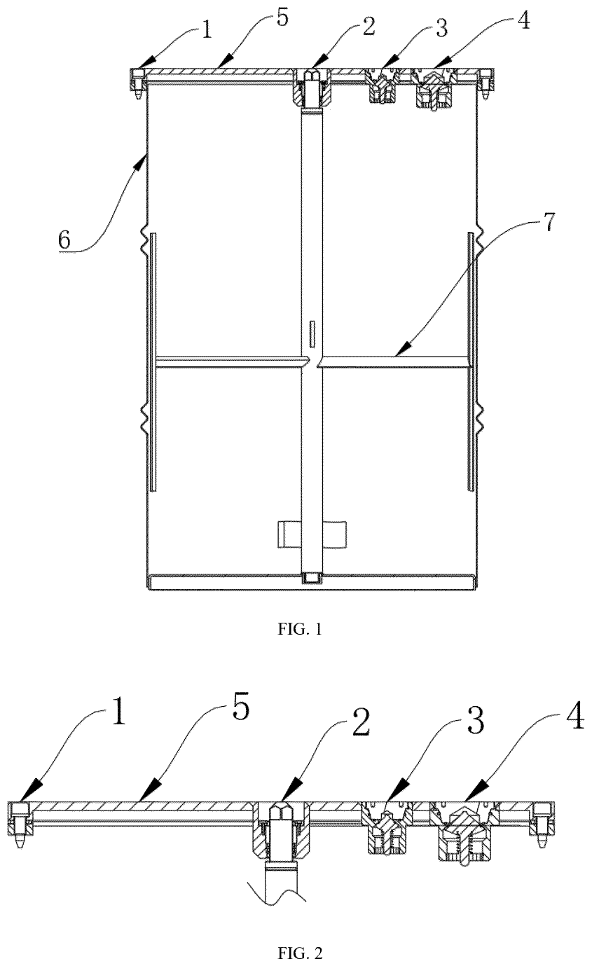

As shown in FIGS. 1 and 2, a paddle discarding stirring bucket for radioactive waste liquid cement solidification in the present invention includes a steel bucket 6, a stirring paddle 7, bucket cover bolts 1, a stirring paddle drive connection end 2, a breathing and exhaust device interface 3, a waste liquid injection interface 4, and a bucket cover 5, where an upper end of the stirring paddle 7 is the stirring paddle drive connection end 2, the stirring paddle drive connection end 2 is integrally formed with the stirring paddle 7, the stirring paddle drive connection end 2 passes through a lower end of the bucket cover 5, an upper segment of the stirring paddle 7 is connected to the bucket cover 5 in a sealed and rotatable manner, a lower segment of the stirring paddle 7 is located inside the stirring steel bucket 6, the breathing and exhaust device interface 3 and the waste liquid injection interface 4 are both arranged on the bucket cover 5, and an edge of the bucket cover 5 is detachably connected to an upper end of the stirring steel bucket 6 by the bucket cover bolts 1.

The paddle discarding fully-sealed cement stirring and solidification bucket of the present invention is not only a packaging container for radioactive waste cement solidification, but also a disposable sealed stirring container. On the basis of meeting the requirements for the disposal of radioactive waste cement solidification packages in the FJ1042-2014 standard, the bucket cover is optimized for process adaptability to meet the process requirements of cement mortar stirring, injection, and exhaust in the bucket under fully-sealed conditions. The wall of the steel bucket 6 is designed with two W-shaped ring ribs to increase the mechanical strength of the steel bucket and meet the requirements of stirring; the stirring paddle 7 is fixed at a center position inside the steel bucket 6, and the stirring paddle drive connection end 2 passes through a stirring interface from the lower end of the bucket cover 5 and extends out of the bucket cover 5; the center of the stirring interface is located at the center of the bucket cover 5, interface sealing components adopt a turning sealing design, the breathing and exhaust device interface 3 and the waste liquid injection interface 4 both adopt spring self-sealing tapered sealing joints and “O”-shaped sealing design, and the steel bucket 6 and the bucket cover 5 are connected by 12 uniformly distributed M16 bucket cover bolts for flange sealing to prevent radioactive gas and waste liquid from overflowing from the interfaces or connections to the outside of the bucket.

A solidification and stirring method for the paddle discarding stirring bucket for radioactive waste liquid cement solidification in the present invention includes the following steps:
S1: The stirring paddle 7, the bucket cover 5, and the stirring steel bucket 6 are assembled and conveyed to a feeding station for cover removal and cement filling; the steel bucket pre-mounted with the stirring paddle is conveyed to the cement feeding station for cover removal; cement dry ash is added on demand to the steel bucket mounted with the stirring paddle according to a water cement ratio in a cement formula, and then the bucket cover is sealed.
S2: The stirring steel bucket 6 is conveyed to a stirring station; a stirring power device, a waste liquid injection device, and a breathing and exhaust device are connected to the stirring paddle drive connection end 2, the waste liquid injection interface 4, and the breathing and exhaust device interface 3 correspondingly (the steel bucket containing cement mortar is moved to the stirring station by means of a motor along a guide rail, and a lifting mechanism of a stirring device is started, so that the stirring interface, the waste liquid interface, and the breathing and exhaust interface are connected to the corresponding interfaces of the solidification bucket; after connection in place, a stop switch is triggered, and the steel bucket descends and stops.) Afterwards, injection and stirring of radioactive waste liquid is carried out in a fully-sealed environment;

The injection and stirring of radioactive waste liquid in the bucket under fully-sealed conditions include three steps: cement dry ash stirring, waste liquid injection and stirring, and uniform mixing:

The purpose of the cement dry ash stirring is to ensure that the cement ash in the solidification steel bucket is in a loose state, which is conducive to liquid injection and stirring, where the stirring time is set to 3-5 minutes, and the stirring speed is set to 60-70 revolutions per minute. The purpose of parameter settings is to ensure that the cement dry ash pre-loaded in the steel bucket is fully loose, which facilitates full contact between cement dry ash and water during subsequent waste liquid injection and prevents the motor from locking due to cement agglomeration.

The waste liquid injection into the steel bucket and stirring is a process of continuously injecting waste liquid into the steel bucket while stirring according to the requirements of the fully-sealed bucket stirring process, including an initial stirring stage and a suspension stirring stage;

The initial stirring stage is a solid-liquid mixing stage, and its key is to control the injection amount and injection time of waste liquid, where the speed of the stirring paddle is 80-90 revolutions per minute;

The injection amount and injection time of waste liquid can be calculated using the following formulas, and the injection amount and injection time of waste liquid in the initial stirring stage are set according to the ranges of parameters in the formulas:

$$V = kW / ρ \qquad ( 1 )$$

$${T}_{0} = kW / Q \qquad ( 2 )$$

V is a cumulative injection amount of waste liquid in the initial stirring stage;
T₀ is an injection time;
ρ is a density of waste liquid;
Q is an injection flow rate of waste liquid, which should be stably controlled at 3-4 cubic meters per hour;
W is a total weight of pre-loaded cement, which can be calculated based on a water cement ratio of a cement solidification formula; and
K is a control coefficient for the cumulative injection amount of waste liquid in the initial stirring stage, ranging from 17% to 22%.

The suspension stirring stage is a solid-liquid suspension mixing stage. To prevent excessive pressure inside the bucket, the injection flow rate of the waste liquid in this stage is reduced to 70-80% of the initial stirring stage until all the waste liquid is injected, and the speed of the stirring paddle remains 80-90 revolutions per minute.

The purpose of controlling the injection amount and injection time of waste liquid is as follows: in the initial stirring stage, the viscosity of the cement mortar in the bucket is high, and the torque output by the stirring device is large, so the injection of a large flow of waste liquid can quickly reduce the viscosity of the cement mortar, facilitates thorough mixing of the waste liquid and the cement dry ash, and prevents burnout of the motor; excessive flow rate or prolonged injection time of waste liquid may increase fluid pressure inside the bucket to damage sealing, which then leads to overflow of the waste liquid.

The uniform mixing includes a thorough mixing stage, a strong stirring stage, and a uniformity improving stirring stage;

The thorough mixing stage is set with a stirring time of 8-10 minutes and a stirring speed of 90-100 revolutions per minute. The purpose of parameter settings is as follows: After the waste liquid is injected, the long-time stirring fully mixes water and cement dry ash to form good cement mortar. Meanwhile, increasing the stirring speed prevents the cement mortar from coagulating near the stirring paddle in the steel bucket to affect the quality of a solidified body.

The strong stirring stage is set with a stirring time of 4-5 minutes and a stirring speed of 120 revolutions per minute. The purpose of parameter settings is as follows: water and cement dry ash are thoroughly mixed after the previous stage of stirring, so in order to avoid residual dry ash at the bottom and wall of the bucket and further increase the stirring speed, all the waste liquid is mixed with the cement dry ash to achieve the set water cement ratio in the cement formula.

the uniformity improving stirring stage is set with a stirring time of 2-3 minutes and a stirring speed of 90-100 revolutions per minute. This stage is a final stage of stirring, and the purpose of parameter settings is to ensure the uniformity of cement mortar formed after the waste liquid is mixed with cement, so that the final cement solidified body meets the requirements.
S3: The stirring steel bucket 6 is transferred to a temporary store for maintenance after the stirring is completed.

### Example 1

According to a water cement ratio of 0.45, 440 kg of cement and 198 L of waste liquid were pre-loaded to a 400 L propeller type steel bucket.
1. The steel bucket pre-mounted with a stirring paddle was conveyed to a cement feeding station for cover removal; 440 kg of cement was added and the bucket cover was sealed.
2. The steel bucket containing the cement was moved to a stirring station by means of a motor along a guide rail, and a lifting mechanism of a stirring device was started, so that a stirring interface, a waste liquid interface, and a breathing and exhaust interface were connected to corresponding interfaces of the solidification bucket; after connection in place, a stop switch was triggered, and the steel bucket descended and stopped.
3. A dry ash stirring operation was carried out, where the stirring time was set to 5 minutes, and the stirring speed was set to 70 revolutions per minute.
4. Waste liquid was injected into the steel bucket and stirred.

In an initial stirring stage, the stirring speed was 80 revolutions per minute, the injection flow rate of radioactive waste liquid was 4 cubic meters per hour, the cumulative injection amount of radioactive waste liquid was controlled at 22% of the total weight of pre-added cement, namely, about 96 L, and the stirring time was 86 seconds;

In a suspension stirring stage, the stirring speed was 80 revolutions per minute, and the injection flow rate of radioactive waste liquid was controlled at 3 cubic meters per hour until the injection of the radioactive waste liquid was completed.
5. A uniform mixing operation was carried out.

A thorough mixing stage was set with a stirring time of 10 minutes and a stirring speed of 100 revolutions per minute;

A strong stirring stage was set with a stirring time of 5 minutes and a stirring speed of 120 revolutions per minute;

A uniformity improving stirring stage was set with a stirring time of 2 minutes and a stirring speed of 100 revolutions per minute.
6. The steel bucket containing the cement mortar was transferred to a temporary store for maintenance.

### Example 2

According to a water cement ratio of 0.5, 413 kg of cement and 207 L of waste liquid were pre-loaded to a 400 L propeller type steel bucket.
1. The steel bucket pre-mounted with a stirring paddle was conveyed to a cement feeding station for cover removal; 413 kg of cement was added and the bucket cover was sealed.
2. The steel bucket containing the cement was moved to a stirring station by means of a motor along a guide rail, and a lifting mechanism of a stirring device was started, so that a stirring interface, a waste liquid interface, and a breathing and exhaust interface were connected to corresponding interfaces of the solidification bucket; after connection in place, a stop switch was triggered, and the steel bucket descended and stopped.
3. A dry ash stirring operation was carried out, where the stirring time was set to 3 minutes, and the stirring speed was set to 60 revolutions per minute.
4. Waste liquid was injected into the steel bucket and stirred.

In an initial stirring stage, the stirring speed was 90 revolutions per minute, the injection flow rate of radioactive waste liquid was 3 cubic meters per hour, the cumulative injection amount of radioactive waste liquid was controlled at 17% of the total weight of pre-added cement, namely, about 70 L, and the stirring time was 84 seconds;

In a suspension stirring stage, the stirring speed was 90 revolutions per minute, and the injection flow rate of radioactive waste liquid was controlled at 2.5 cubic meters per hour until the injection of the radioactive waste liquid was completed.
5. A uniform mixing operation was carried out.

A thorough mixing stage was set with a stirring time of 10 minutes and a stirring speed of 90 revolutions per minute;

A strong stirring stage was set with a stirring time of 5 minutes and a stirring speed of 120 revolutions per minute;

A uniformity improving stirring stage was set with a stirring time of 2 minutes and a stirring speed of 90 revolutions per minute.
6. The steel bucket containing the cement mortar was transferred to a temporary store for maintenance.

The technical solution of the present invention is not limited to the specific embodiments described above, and any technical modification made based on the technical solution of the present invention falls within the scope of protection of the present invention.

What is claimed is:

1. A paddle discarding fully-sealed cement stirring and solidification bucket, comprising a steel bucket, a stirring paddle, bucket cover bolts, a stirring paddle drive connection end, a breathing and exhaust device interface, a waste liquid injection interface, and a bucket cover, wherein an upper end of the stirring paddle is the stirring paddle drive connection end, the stirring paddle drive connection end is integrally formed with the stirring paddle, the stirring paddle drive connection end passes through a lower end of the bucket cover, an upper segment of the stirring paddle is connected to the bucket cover in a sealed and rotatable manner, a lower segment of the stirring paddle is located inside the stirring steel bucket, the breathing and exhaust device interface and the waste liquid injection interface are both arranged on the bucket cover, and an edge of the bucket cover is detachably connected to an upper end of the stirring steel bucket by the bucket cover bolts.

2. A liquid injection and stirring method for the paddle discarding fully-sealed cement stirring and solidification bucket according to claim 1, comprising the following steps:
S1: assembling the stirring paddle, the bucket cover, and the stirring steel bucket and then conveying them to a feeding station for cover removal and cement filling;
S2: conveying the stirring steel bucket to a stirring station, connecting a stirring power device, a waste liquid injection device, and a breathing and exhaust device to the stirring paddle drive connection end, the waste liquid injection interface, and the breathing and exhaust device interface correspondingly, and then carrying out injection and stirring of radioactive waste liquid in a fully-sealed environment; and
S3: transferring the stirring steel bucket to a temporary store for maintenance after the stirring is completed.

3. The liquid injection and stirring method for the paddle discarding fully-sealed cement stirring and solidification bucket according to claim 2, wherein the injection and stirring of radioactive waste liquid in the fully-sealed environment in step S2 comprises three steps: cement dry ash stirring, waste liquid injection into the steel bucket and stirring, and uniform mixing.

4. The liquid injection and stirring method for the paddle discarding fully-sealed cement stirring and solidification bucket according to claim 3, wherein the cement dry ash stirring is set with a stirring time of 3-5 minutes and a stirring speed of 60-70 revolutions per minute.

5. The liquid injection and stirring method for the paddle discarding fully-sealed cement stirring and solidification bucket according to claim 3, wherein the waste liquid injection into the steel bucket and stirring comprise an initial stirring stage and a suspension stirring stage;
the initial stirring stage is a solid-liquid mixing stage in which the speed of the stirring paddle is 80-90 revolutions per minute;
the injection amount and injection time of waste liquid are calculated using the following formulas, and the injection amount and injection time of waste liquid in the initial stirring stage are set according to the ranges of parameters in the formulas:
$$V = kW / ρ \qquad ( 1 )$$
$${T}_{0} = kW / Q \qquad ( 2 )$$
V is a cumulative injection amount of waste liquid in the initial stirring stage;
T₀ is an injection time;
ρ is a density of waste liquid;
Q is an injection flow rate of waste liquid, stably controlled at 3-4 cubic meters per hour;
W is a total weight of pre-loaded cement, calculated based on a water cement ratio of a cement solidification formula;
K is a control coefficient for the cumulative injection amount of waste liquid in the initial stirring stage, ranging from 17% to 22%;
the suspension stirring stage is a solid-liquid suspension mixing stage, the injection flow rate of the waste liquid is reduced to 70-80% of the initial stirring stage until all the waste liquid is injected, and the speed of the stirring paddle remains 80-90 revolutions per minute.

6. The liquid injection and stirring method for the paddle discarding fully-sealed cement stirring and solidification bucket according to claim 3, wherein the uniform mixing comprises a thorough mixing stage, a strong stirring stage, and a uniformity improving stirring stage;
the thorough mixing stage is set with a stirring time of 8-10 minutes and a stirring speed of 90-100 revolutions per minute;
the strong stirring stage is set with a stirring time of 4-5 minutes and a stirring speed of 120 revolutions per minute; and
the uniformity improving stirring stage is set with a stirring time of 2-3 minutes and a stirring speed of 90-100 revolutions per minute.
